(19) United States
(12) Patent Application Publication
(10) Pub. No.: US 2008/0198685 A1
(43) Pub. Date: Aug. 21, 2008

(54) Method of Preparing Sea Bed for Jack Up Rig Deployment

(76) Inventor: Kevin B. Umbehr, The Woodlands, TX (US)

Correspondence Address: DUANE MORRIS LLP, 3200 SOUTHWEST FREEWAY, SUITE 3150, HOUSTON, TX, 77027, US

(21) Appl. No.: 11/675,449

(22) Filed: Feb. 15, 2007

(51) Int. Cl. B28C 7/04

(52) U.S. Cl. 366/8

(57) ABSTRACT

A method of filling seabed holes involves vessels that locate the holes with sonar and one of which has onboard capabilities for storage of a solid and mixing it with liquid to create a pumpable slurry. The slurry is delivered through a coiled line that is fed out overboard and the end of the line is held in position by maintaining the vessel at the desired location during slurry pumping. The hose end can be held fixed or progressively raised during slurry delivery, depending on the starting depth. The hose further has an end feature that counteracts the tendency of the hose to whip from the force created by the pumped slurry exiting the end. The slurry encounters a plate at the hose end with lateral exits preferably equally spaced circumferentially to maintain the hose end in a steady position as the slurry is delivered.

### FIELD OF THE INVENTION

The field of the invention is preparation of seabed for deployment of jack up rigs in locations previously occupied by another rig where the seabed surface has large depressions that can adversely affect the stability of another rig jacked into the location.

### BACKGROUND OF THE INVENTION

When jack up rigs are deployed, their legs are powered down to the seabed for support. The loads on each leg are high and the base of each leg tends to sink into the seabed making a large depression. In some cases, a depression can be over 40 feet deep and around a hundred feet across. The bottoms of the legs are generally flat with plates going up from the bottom and around the bottom of the leg. The impression or foot print on the seabed made by each leg is referred to as a “can hole” or a “spud can footprint” after the appearance of a leg lower end.

Many times a jack up is moved off location and, at a later time, another jack up needs to go back to that location to work on an existing well or another well that will be drilled in the same vicinity. The can holes that are in the vicinity present a stability risk to the subsequent jack up as the stability of the structure is endangered by these huge divots in the seabed that any given leg could enter either partially or totally.

Past efforts to level the seabed before the arrival of another jack up have been expensive and ineffective. In one technique a barge laden with sand is brought to the vicinity of the can hole and the sand is simply bulldozed overboard. Currents divert much of the sand pushed off the barge so that it misses the can hole that needs filling. In shallow depths, generally below 90 feet, an underwater dredge can be used. However, the Army Corps of Engineers has complete control over the use of such devices and their use is not cheap. Furthermore, environmental studies are generally required for dredging work and that has its own set of built in delays to get the required approvals.

The present invention provides an effective technique for depositing fill material where it is needed. It involves a vessel to bring the material to the site that has onboard facilities to mix solid and liquid into a pumpable slurry. The delivery system involves navigation equipment to position a slurry delivery line in the proper position during the delivery. Features are added to the delivery line exit to stabilize it against reaction from the slurry exit force. The line can be positioned in a single spot somewhat close to the center of the can hole and at about the level of the surrounding sea bed. Alternatively, the line can begin delivery of slurry within the can hole and be raised during delivery until the hole is suitably filled. These and other advantages of the present invention will be more readily appreciated by those skilled in the art from a review of the description of the preferred embodiment and the associated drawing while recognizing that the claims define the full scope of the invention.

### SUMMARY OF THE INVENTION

A method of filling seabed holes involves vessels that locate the holes with sonar and one of which has onboard capabilities for storage of a solid and mixing it with liquid to create a pumpable slurry. The slurry is delivered through a coiled line that is fed out overboard and the end of the line is held in position by maintaining the vessel at the desired location during slurry pumping. The hose end can be held fixed or progressively raised during slurry delivery, depending on the starting depth. The hose further has an end feature that counteracts the tendency of the hose to whip from the force created by the pumped slurry exiting the end. The slurry encounters a plate at the hose end with lateral exits preferably equally spaced circumferentially to maintain the hose end in a steady position as the slurry is delivered.

### BRIEF DESCRIPTION OF THE DRAWINGS

FIG. 1 is a schematic view showing the use of the method; and

FIG. 2 is a section view through lines 2-2 of FIG. 1.

### DETAILED DESCRIPTION OF THE PREFERRED EMBODIMENT

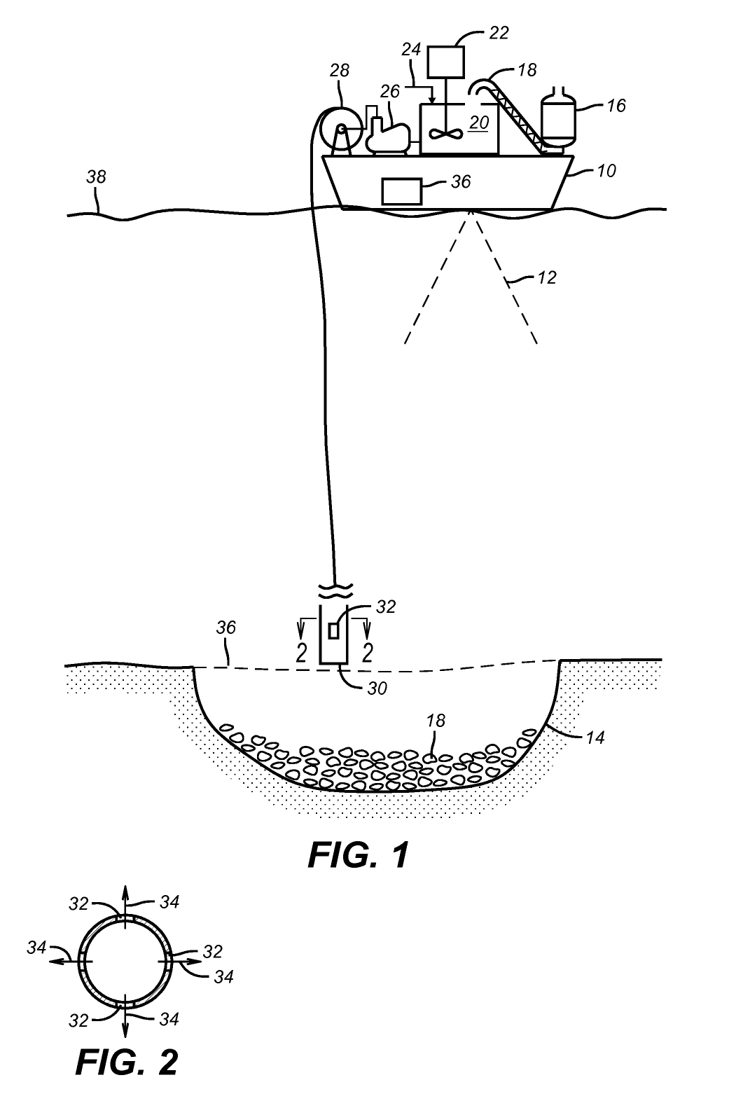

FIG. 1 shows a vessel 10 that has sonar equipment schematically illustrated as 12 to allow it to find one or more can holes 14. The vessel 10 has one or more storage tanks 16 for solid material such as beach sand 18 to be delivered as a slurry into the can hole 14. The tank 16 delivers sand by screw conveyor 18 into mix tank 20. The mix tank 20 has a motorized agitator 22 and a seawater feed line 24. One or more slurry pumps 26 deliver the mixed slurry from tank 20 to reeled hose 28. The lower end 30 of hose 28 is blanked off and the slurry 34 escapes radially through equally spaced ports 32 shown circumferentially distributed at 90 degrees in FIG. 2. A positioning system 36 is integrated with the vessel steering system to hold the position of lower end 30 in as steady a position as possible while the slurry 34 is delivered into the can hole 14.

Those skilled in the art will appreciate that the various can holes in a given location can in series be filled in the same manner. While beach sand is preferred as the solid material for ease of handling and lower wear and tear on the delivery equipment, other solids that can be made into a slurry and pumped can be used as alternates. The lower end is preferably suspended at the average depth 36 of the seabed that surrounds the can hole 14. One reason for this is to avoid a pile of sand that covers the end 30 which in combination with normal movement of the vessel 10 on the waterline 38 could rip the hose 28 or pull its associated reel overboard. However, some can holes are nearly 50 feet deep and over 100 feet in diameter. In the larger can hole operations it is also possible to start the lower end 30 below the average seabed depth 36 so that it begins literally in the can hole 14. In this version of the method, the sonar equipment gives feedback as to the sand profile development in the can hole. As the height of the pile increases the lower end 30 is raised up. When the can hole is sufficiently full, the hose 28 is pulled back into the vessel 10 and the jack up is brought into position and the legs extended with confidence that the jack up will be planted on a relatively level seabed 36.

While openings at 90 degrees are shown in FIG. 2, other spacing and clusters of openings can used instead of single spaced openings. The opening shape can be varied and should be large enough to avoid high back pressure and high velocities that can cause hole opening erosion.

The above description is illustrative of the preferred embodiment and many modifications may be made by those skilled in the art without departing from the invention whose scope is to be determined from the literal and equivalent scope of the claims below.

I claim:

1. A method of filling depressions in a seabed in preparation for deployment of a rig, comprising:
positioning a vessel holding filler material in the vicinity of the depression;
delivering the filler material to a location at least adjacent the depression through a conduit.

2. The method of claim 1, comprising:
using a flexible line as said conduit.

3. The method of claim 1, comprising:
stabilizing said conduit at its lower end against whipping from the force of filler material exiting said lower end.

4. The method of claim 3, comprising:
forcing the filler material to exit laterally from adjacent said lower end.

5. The method of claim 4, comprising:
distributing said lateral exits symmetrically.

6. The method of claim 5, comprising:
preventing filler material from exiting straight out the end of said conduit.

7. The method of claim 2, comprising:
locating said end of said conduit at a fixed depth with respect to said vessel while said filler material is delivered.

8. The method of claim 2, comprising:
locating said end of said conduit at a variable depth with respect to said vessel while said filler material is delivered.

9. The method of claim 8, comprising:
raising said end during delivery of said filler material.

10. The method of claim 9, comprising:
selecting an initial position of said end within said depression.

11. The method of claim 1, comprising:
using sonar to locate said depression.

12. The method of claim 1, comprising:
using global positioning to maintain vessel position as said filler material is delivered.

13. The method of claim 1, comprising:
using sand as said filler material.

14. The method of claim 13, comprising:
slurrying said sand with seawater to deliver it to said conduit.

15. The method of claim 1, comprising:
pumping said filler material down said conduit as a slurry.

16. The method of claim 7, comprising:
using sand as said filler material.

17. The method of claim 8, comprising:
using sand as said filler material.
